(19) United States
(12) Patent Application Publication
(10) Pub. No.: US 2009/0254517 A1
(43) Pub. Date: Oct. 8, 2009

(54) System And Method For Generating Messages

(76) Inventor: Dilip Dalton, San Jose, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/239,316

(22) Filed: Sep. 26, 2008

Related U.S. Application Data
(60) Provisional application No. 61/042,457, filed on Apr. 4, 2008.

(51) Int. Cl. G06F 17/30; G06F 9/46

(52) U.S. Cl. 707/2; 718/102; 707/E17.001

(57) ABSTRACT

A method and system for generating messages are described. The method and system include retrieving information regarding a plurality of tasks from a database and based on the information retrieved, determining whether notifications for the tasks need to be generated. The method and system further include determining a recipient for each notification, grouping the tasks based on the recipient of each notification and generating a message for each group of tasks.

### BACKGROUND

In a project management system, there are typically a number of tasks that make up a project. Each task may be assigned to one or more resources (i.e., people or entities) and each resource may be assigned one or more tasks within the same project. Resources often need to be notified by electronic mail or another method of communication on the occurrence of certain events associated with a task such as when a task is about to begin or a task is late to start or end.

FIG. 1 shows a sample set of tasks 100 that may exist in a project management system. The tasks in FIG. 1 are organized in a hierarchical work breakdown structure.

The hierarchy of tasks in FIG. 1 includes tasks at three levels. “Change roof” with task ID 101 is the root task and has four immediate child tasks, “place order” with task ID 102, “prepare for storing shingles” with task ID 103, “prepare roof for install” with task ID 104 and “install roof” with task ID 107. The “prepare roof for install” task has two child tasks, “remove old shingles” with task ID 105 and “clean area” with task ID 106. Similarly, the “install roof” task has two child tasks, “receive shingles” with task ID 108 and “install new shingles” with task ID 109.

In a project management system, a notification definition typically defines attributes for a notification message that is sent out for a task. These attributes might include information such as when a notification should be sent (i.e., on late start or end of a task), to whom a notification should be sent (i.e., a vendor or customer) and the text that should be sent in the notification message (i.e., “The “install roof” task will be starting late.”).

As shown in FIG. 1, the “change roof” task with task ID 101 is associated with notification definition Notif1 and recipients Installer, Seller and Customer; the “prepare roof for install” task with task ID 104 is associated with notification definition Notif2 and recipients Installer and Customer; and the “install roof task” with task ID 107 is associated with notification definition Notif3 and the Seller recipient. Notif1, Notif2 and Notif3 in the embodiment of FIG. 1 are inherited by the tasks that are immediately one level below the task to which they belong. For example, in FIG. 1, Notif2 is inherited by the “remove old shingles” and “clean area” child tasks of the “prepare roof for install” task.

Referring to FIG. 1, if the following four tasks—“place order,” “prepare for storing shingles,” “remove old shingles,” and “receive shingles”—were late to start or finish, messages would be generated and sent to the associated recipients, provided that this was called for in each task's notification definition.

FIG. 2 illustrates the number of e-mail messages that would be generated by a conventional project management system in the foregoing scenario. As shown in FIG. 2, nine e-mail messages are generated by the portfolio and project management server (PPM) 200 using the task information stored in database 202 and then sent to the recipients, Installer 206, Seller 216 and Customer 226, over network 204.

In this scenario, messages for each of the “place order” “prepare for storing shingles” and “remove old shingles” tasks, 210, 212 and 214 respectively, are sent to the Installer 206. Similarly, messages for each of the “place order,” “prepare for storing shingles” and “receive shingles” tasks, 220, 222 and 224 respectively, are sent to the Seller 216. Likewise, messages for each of the “place order,” “prepare for storing shingles” and “remove old shingles” tasks, 230, 232 and 234 respectively, are sent to the Customer 226.

Accordingly, when a sizeable project is being managed using such a conventional project management system, a large number of e-mails are generated, resulting in the use of a significant amount of processing power and memory on the PPM/mail server and network bandwidth.

### SUMMARY

Various embodiments disclosed herein are directed to helping reduce the number of messages generated and resources used by a system.

An embodiment includes a method for generating messages comprising retrieving information regarding a plurality of tasks from a database and based on the information retrieved, determining whether notifications for the tasks need to be generated. The method further includes determining a recipient for each notification, grouping the tasks based on the recipient of each notification and generating a message for each group of tasks.

In one aspect, the method further includes tasks that have a hierarchical structure. In another aspect, the method includes a database with information regarding the start and end of each task and generates a message for tasks that are late. In yet another aspect, the method includes storing information pertaining to the groups of tasks in either the database or a temporary data structure. The temporary data structure can be a Hash Map and each task may be associated with a task ID and task IDs may be grouped together to form a key in the Hash Map. Furthermore, recipients may be grouped together to form a value associated with the key. In yet another aspect, the generated messages are one of electronic mail messages, text messages and voicemail messages.

Another embodiment includes a system for reducing the number of generated notification messages comprising a database storing information regarding a plurality of tasks, notification definitions and notification recipients, wherein at least a subset of the tasks are each associated with a notification definition and a notification recipient; and a server determining which tasks, based on their associated notification definitions, require a notification message, grouping the tasks requiring notification messages together and grouping recipients together, and generating notification messages based on the groupings of tasks and recipients.

Another embodiment includes a method for generating notification messages comprising retrieving from a database data pertaining to a plurality of notifications, and a recipient and a source associated with each notification; ordering the notifications first by recipient and then by source; grouping the notifications based on both their source and recipients; and generating a message for each group of notifications.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is shows a sample group of tasks for which e-mails can be generated using an embodiment disclosed herein;

FIG. 2 is a high-level diagram of a conventional system for grouping e-mails;

FIG. 3 is a high-level diagram of a system according to an embodiment disclosed herein;

FIGS. 4A and 4B show a class diagram illustrating an embodiment; and

FIG. 5 is a flowchart illustrating an embodiment using the class structure shown in FIGS. 4A and 4B.

### DETAILED DESCRIPTION

Reference will now be made in detail to various embodiments, which are illustrated in the accompanying drawings.

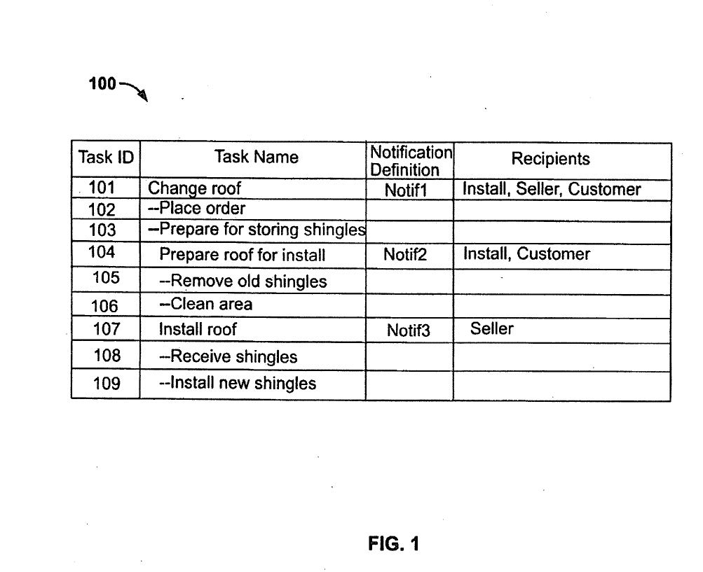

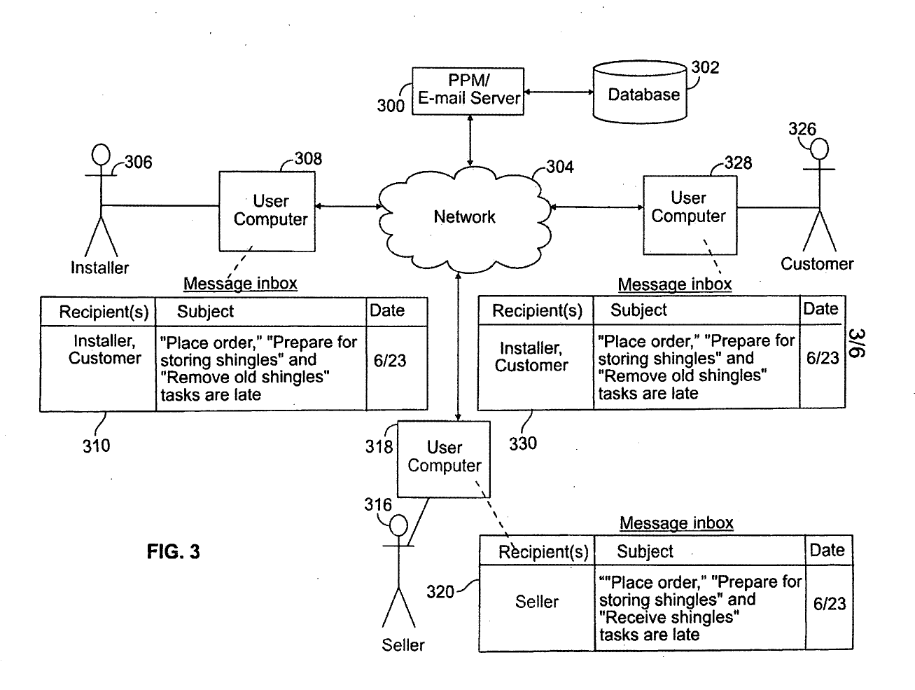

The various embodiments are described herein in view of the exemplary tasks shown in table 100 of FIG. 1. In describing the embodiments shown in FIGS. 3, 4 and 5, the “place order” task with task ID 102, the “prepare for storing shingles” task with task ID 103, the “remove old shingles” task with task ID 105 and the “receive shingles” task with task ID 108 are presumed to be late to start or end.

Two ways to address the problem of reducing the number of notification messages generated and sent by a project management or other type of system are by generating one message per task or one message per recipient.

Using the one message per task technique would result in four messages. One message addressed to the Installer, Seller and Customer would be generated indicating that the “place order task” is late. Similarly, one message addressed to the Installer, Seller and Customer would be generated indicating that the “prepare for storing shingles” task is late. Likewise, one message addressed to the Installer and Customer would be generated indicating that the “remove old shingles” task is late. And finally, one message addressed to the Seller would be generated indicating that the “receive shingles” task is late.

In the alternative, using the one message per recipient technique would result in three messages. One message addressed to the Installer would be generated stating that the “place order,” “prepare for storing shingles” and “remove old shingles” tasks are late. Similarly, one message addressed to the Seller would be generated stating that the “place order,” “prepare for storing shingles” and “receive shingles tasks are late. In addition, one message addressed to the Customer would be generated stating that the “place order,” “prepare for storing shingles” and “remove old shingles” tasks are late.

FIGS. 3, 4 and 5 illustrate embodiments that would further reduce the number of messages generated in the foregoing scenario to only two messages by grouping messages based on both their content and intended recipients.

FIG. 3 illustrates a PPM/mail server 300 that generates e-mails based on task and associated notification and recipient information stored in database 302. The PPM server 300 sends the generated e-mails to the Installer 306, Seller 316 and Customer 326, which view the messages in their e-mail inbox using the computers 308, 318 and 328 respectively.

Assuming that the four tasks—“place order,” “prepare for storing shingles,” “remove old shingles” and “receive shingles”—are late, the PPM server 300 as shown in the embodiment of FIG. 3 generates only two e-mail notification messages. Accordingly, the PPM server 300 generates one message addressed to the Installer 306 and Customer 326, which is illustrated as message 310 in the Installer's 306 message inbox and message 330 in Customer's 326 message inbox. The message, 310 and 330, indicates that the “place order,” “prepare for storing shingles” and “remove old shingles” tasks are late. The PPM server 300 also generates a second message 320 addressed to Seller 316, which indicates that the “place order,” “prepare for storing shingles” and “receive shingles” tasks are late.

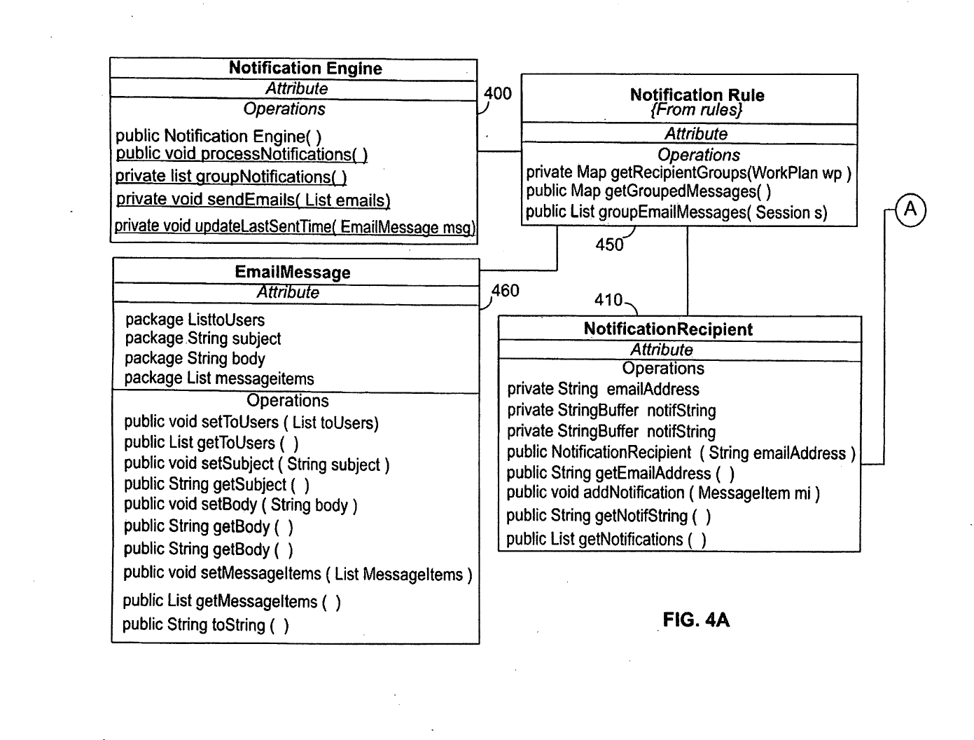

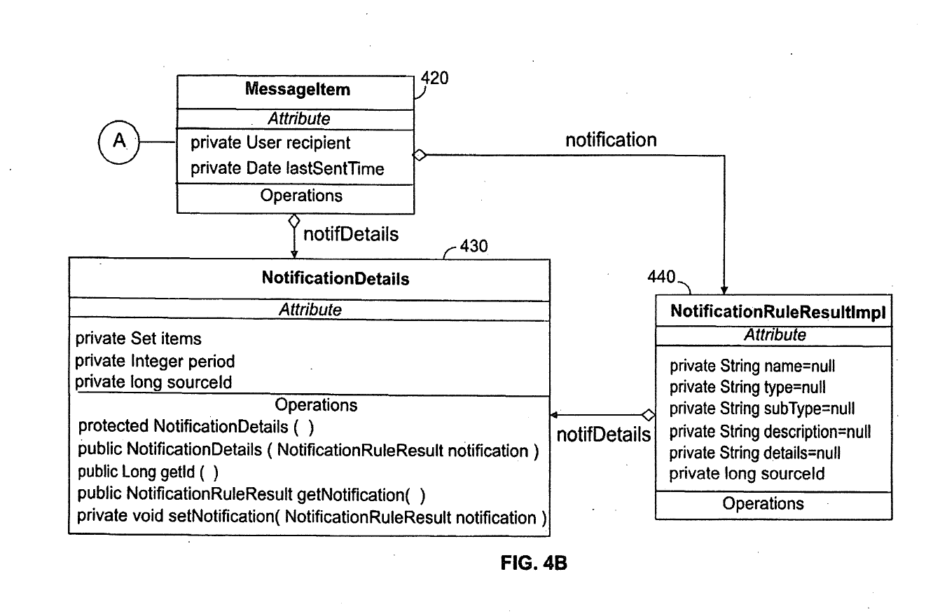

FIGS. 4A and 4B show a class diagram illustrating an embodiment using an object-oriented approach. It should be noted that the concepts illustrated in FIGS. 4A and 48 can likewise be implemented using a non-object-oriented approach.

The class diagram shown in FIGS. 4A and 4B includes the NotificationEngine class 400, the NotificationRule class 450, the EmailMessage class 460, the NotificationRecipient class 410, the MessageItem class 420, the Notification Details class 430 and the NotificationRuleResultImpl class 440.

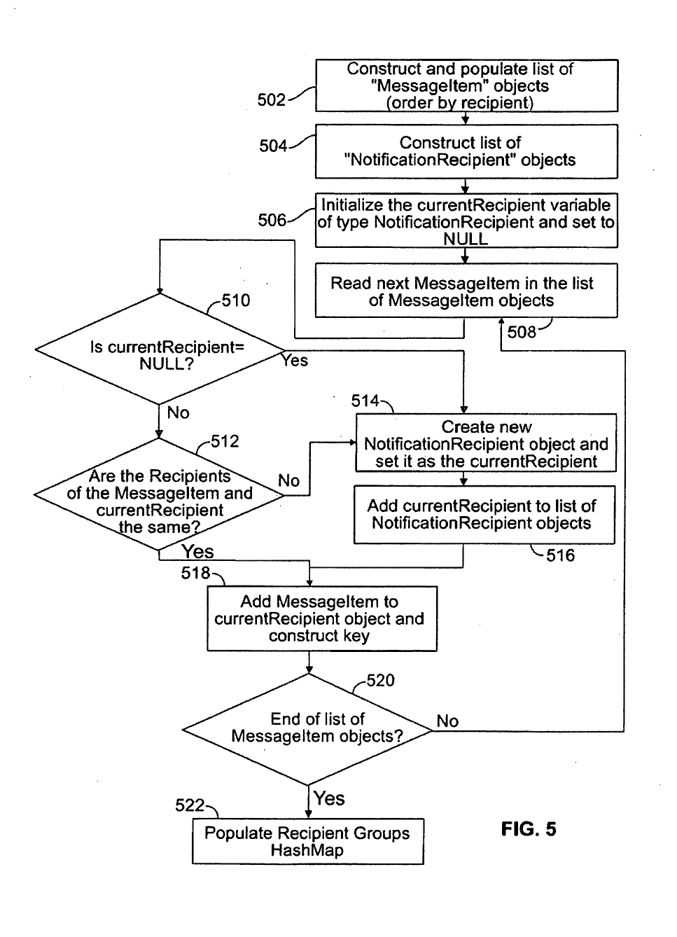

In the embodiment shown in FIGS. 4A and 4B, the NotificationEngine class 400 kicks off the processing of notification messages. The NotificationRule class 450 contains the grouping algorithm depicted by the flowchart of FIG. 5, which is explained below. The EmailMessage class 460 contains attributes of the resulting e-mail messages that will be sent to users.

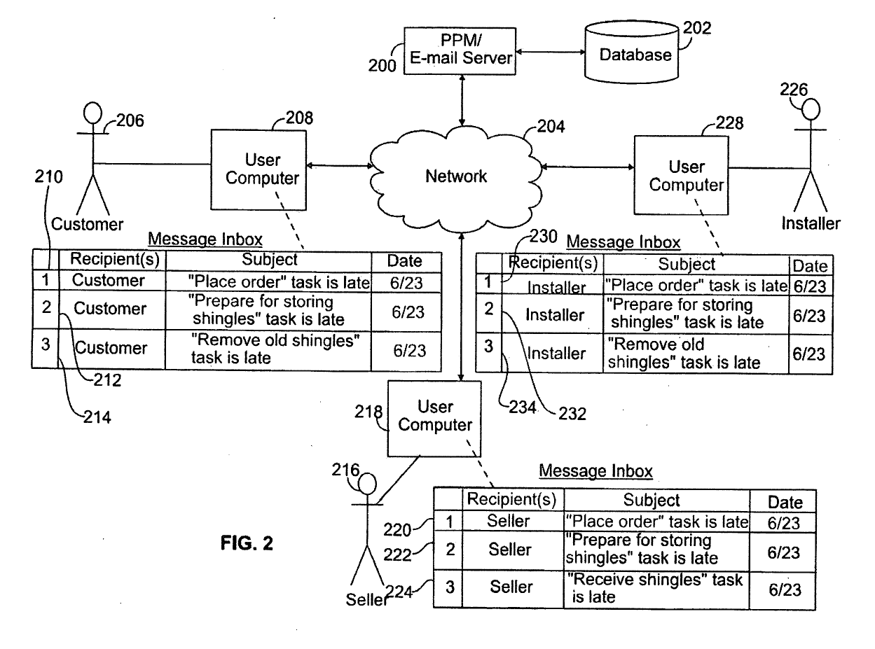

An instance of the NotificationRecipient class 410 is created for each recipient when processing notifications. Accordingly, in the embodiment of FIG. 3, there would be an instance of the NotificationRecipient class 410 created for each of the Installer 306, the Seller 316 and the Customer 326. The NotificationRecipient class 410 has two key attributes: the emailAddress of the recipient and the notifString attribute, which, in the present embodiment, is a key representing the notifications that are to be sent to the emailAddress. Accordingly, the notifString attribute in the present embodiment corresponding to the Installer 106 of FIG. 2 would be “102:103:105,” which is comprised of the task IDs listed in table 100 of FIG. 1 for each of the notifications the Installer should receive, separated by colons. Similarly, the notifString attribute corresponding to the Seller 118 would be 102:103:108 and the notifString attribute corresponding to the Customer 126 would be 102:103:105. The NotificationRecipient class 410 further includes a list of MessageItems 420 belonging to a recipient.

In the present embodiment, there exists a many to many relationship between the source and the recipient and the MessageItem class 420 is used to represent this relationship. Thus, one source can have many recipients and many sources can have the same recipient.

An instance of the MessageItem class 420 is created for each notification. The MessageItem class 420 is an aggregate of the NotificationDetails class 430 and has notification details. The MessageItem class 420 is also an aggregate of the NotificationRuleResultImpl class 440. The MessageItem class 420 includes information regarding the recipient receiving the notification and is linked to a sourceID via the NotificationDetails class 430. In the present embodiment, the sourceID would be a task ID shown in table 100 of FIG. 1.

In the present embodiment, a Hashmap data structure is used to store information pertaining to groups of recipients and groups of notifications (the “Recipient Groups Hashmap”). A Hashmap data structure usually associates keys with values and is known for fast searches. It should be noted that in alternative embodiments, data can be stored in other types of data structures or in a database.

The following is an illustration of the Recipient Groups Hashmap that is created by the method illustrated in the flowchart in FIG. 5:

| Key | Value |
|---|---|
| 102:103:105 | Installer, Customer |
| 102:103:108 | Seller |

In the Recipient Groups Hashmap, the key is made up of the task IDs of each of the notifications to be sent to a group of recipients. The group of recipients make up the value corresponding to the key. Accordingly, the key for the recipients group made up of Installer and Customer is 102:103:105 because Installer and Customer are to receive notifications corresponding to task IDs 102, 103 and 105, which respectively correspond to the “place order,” “prepare for storing shingles” and “remove old shingles” tasks. Similarly, the key for the recipients group made up of Seller is 102:103:108 because Seller is to receive notifications corresponding to task IDs 102, 103, 108, which respectively correspond to the “place order,” “prepare for storing shingles” and “receive shingles” tasks.

FIG. 5 is a flowchart illustrating an embodiment using the class structures shown in FIGS. 4A and 4B.

In step 502 of FIG. 5, a list of MessageItem 420 objects is constructed. This list is also populated in step 502 as follows:

Messageitem1 [Recipient: Customer, SourceID: 102]

Messageitem2 [Recipient: Customer, SourceID: 103]

Messageitem3 [Recipient: Customer, SourceID: 105]

Messageitem4 [Recipient: Installer, SourceID: 102]

Messageitem5 [Recipient: Installer, SourceID: 103]

Messageitem6 [Recipient: Installer, SourceID: 105]

Messageitem7 [Recipient: Seller, SourceID: 102]

Messageitem8 [Recipient: Seller, SourceID: 103]

Messageitem9 [Recipient: Seller, SourceID: 108]

As can be seen above, in the present embodiment, the list of MessageItem 420 objects is sorted first by Recipient and second by SourceID (same as task ID from table 100). In alternative embodiments, the list may be sorted only by Recipient or by other attributes.

In step 504, an empty list of NotificationRecipient 410 objects is constructed. As previously noted, in the present embodiment, there will be one instance of the NotificationRecipient 410 object created for each recipient, or in other words, one for each of the Installer 306, the Seller 316 and the Customer 326.

In step 506, a variable called currentRecipient is initialized and set to null or empty. In step 508, the first MessageItem in the MessageItem list populated in step 502 is read.

Next, step 510 checks whether the currentRecipient variable is null or empty. On the first pass of step 510, the currentRecipient variable would be null or empty and the method would proceed to step 514. If the current Recipient variable is not null or empty, the method would proceed to step 512, which checks if the recipient of the current MessageItem in the list, which was read in step 508, and the recipient in the currentRecipient object are the same. If the two recipients are the same, then the method skips steps 514 and 516 and proceeds to step 518. If the two recipients are different, however, the method proceeds to step 514.

In step 514, a new NotificationRecipient 410 object is created and set as the currentRecipient. Next, in step 516, the newly created currentRecipient object is added to the list of NotificationRecipient objects created in step 504.

Next, in step 518, the MessageItem read in step 508 is added to the currentRecipient object. In addition, the key that will later be used to populate the Recipient Groups HashMap in step 522 is constructed in step 518 and stored in the notifString attribute of the currentRecipient object. Thus, for MessageItem1, the notifString attribute would be set to “102.” When MessageItem2 is processed by step 518 during the second pass, the notifString attribute would be modified to “102:103” and so forth.

After step 518, step 520 checks whether the end of the MessageItems list has been reached. If there are more MessageItems in the list, then the method will loop back to step 508. If the end of the list has been reached, then the method will proceed to step 522, which populates the Recipient Groups HashMap.

In the present embodiment, the Recipient Groups HashMap is populated by cycling through each of the NotificationRecipient objects in the list of NotificationRecipient objects created by steps 502-520, and determining whether the value in the notifString attribute of the NotificationRecipient object is present in the Recipient Groups HashMap. If the key is present, then the associated value, which contains the corresponding group of recipients would be appended with the recipient of the current NotificationRecipient object. If the key is not present, then a new key-value combination would be added to the Recipient Groups HashMap in which the key would be the notifString attribute of the current NotificationRecipient object and the value would be the recipient of the current NotificationRecipient object.

Messages can be generated using the keys and values stored in the Recipient Groups HashMap as soon as the Recipient Groups HashMap is populated or at a later time. Because the HashMap data structure takes up little space, storing the relevant information in the Recipient Groups HashMap is more efficient than storing generated e-mails for delivery at a later time.

In the present embodiment, one e-mail is generated for each record in the Recipient Groups HashMap. Specifically, because the resulting Recipient Groups HashMap of the present embodiment would contain 2 records, the first record having a key equal to “102:103:105” and a value equal to “Installer, Customer” and the second record having a key equal to “102:103:108” and a value equal to “Seller,” two notification messages are generated as shown in FIG. 3. The first message is addressed to the Installer 306 and Customer 326, which is illustrated as message 310 in the Installer's 306 message inbox and message 330 in Customer's 326 message inbox. This message, 310 and 330, would indicate that the “place order,” “prepare for storing shingles” and “remove old shingles” tasks are late. The second message 320 is addressed to Seller 316 and would indicate that the “place order,” “prepare for storing shingles” and “receive shingles” tasks are late.

While the embodiments disclosed herein can be implemented in various ways, some advantages of the embodiment of FIG. 5 include that the construction of the Recipient Groups HashMap is fast and the grouping of e-mails can be done on the fly. In addition, grouping based on the key of the HashMap allows for fast searching. Also, the comparison speed for n NotificationRecipient objects is close to O(n) because the key is sufficient for comparing the structure of the content of the e-mail messages. Moreover, the size of the Recipient Groups HashMap structure is small compared to the size of the contents of the resulting e-mail messages and therefore, memory consumption is fairly low.

An alternative embodiment to the embodiment depicted in FIG. 5 groups e-mails based on a literal comparison of the contents of messages. In this embodiment, the text of the e-mails would have to be generated first, followed by a more time-consuming string comparison.

In an embodiment, the network 304 can be a LAN, WAN, Bluetooth, Wi/Fi, cellular/PCS or any other wired or wireless network. In another embodiment, text messages, voicemail, audio or video messages are sent instead of e-mail. In an embodiment, an end user views or listens to messages on a desktop, laptop, PDA, cellular phone, pager or any device capable of displaying text or playing audio or video. In an embodiment, the methods described herein may run on one server or be distributed among multiple servers.

The systems and methods described herein are not limited to project management systems. Thus, in other embodiments, the systems and methods described herein are applied to a system that sends messages with similar content or structure to multiple people.

Various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for generating messages comprising:
retrieving information regarding a plurality of tasks from a database;
based on the information retrieved, determining whether notifications for the tasks need to be generated;
determining a recipient for each notification;
grouping the tasks based on the recipient of each notification; and
generating a message for each group of tasks.

2. The method of claim 1, wherein the tasks have a hierarchical structure.

3. The method of claim 1, wherein the database includes information regarding the start and end of each task and a message is generated for tasks that are late.

4. The method of claim 1, wherein before generating the message, information pertaining to the groups of tasks is stored in one of the database and a temporary data structure.

5. The method of claim 4, wherein the temporary data structure is a Hash Map.

6. The method of claim 5, wherein each task has a task ID and task IDs are grouped together to form a key in the Hash Map and recipients are grouped together to form a value associated with the key.

7. The method of claim 1, wherein the generated messages are one of electronic mail messages, text messages and voicemail messages.

8. A system for reducing the number of generated notification messages comprising:
a database storing information regarding a plurality of tasks, notification definitions and notification recipients, wherein at least a subset of the tasks are each associated with a notification definition and a notification recipient; and
a server determining which tasks, based on their associated notification definitions, require a notification message, grouping the tasks requiring notification messages together and grouping recipients together, and generating notification messages based on the groupings of tasks and recipients.

9. The system of claim 8, wherein the plurality of tasks have a hierarchical structure.

10. The system of claim 8, wherein the database includes information regarding the start and end of each task and the server generates notification messages if tasks are late.

11. The system of claim 8, wherein information pertaining to the grouping of tasks is stored in one of the database and a temporary data structure.

12. The system of claim 11, wherein the temporary data structure is a Hash Map.

13. The system of claim 12, wherein each task has a task ID and task IDs are grouped together to form a key in the Hash Map and recipients are grouped together to form a value associated with the key.

14. The system of claim 8, wherein the generated messages are one of electronic mail messages, text messages and voicemail messages.

15. A method for generating notification messages comprising:
retrieving from a database data pertaining to a plurality of notifications, and a recipient and a source associated with each notification;
ordering the notifications first by recipient and then by source;
grouping the notifications based on both their source and recipients; and
generating a message for each group of notifications.

16. The method of claim 15, wherein the notifications are associated with tasks having a hierarchical structure.

17. The method of claim 15, wherein information pertaining to the grouping of notifications is stored in one of the database and a temporary data structure.

18. The method of claim 17, wherein the temporary data structure is a Hash Map.

19. The method of claim 18, wherein the notifications are associated with tasks, each task having a task ID and task IDs are grouped together to form a key in the Hash Map and recipients are grouped together to form a value associated with the key.

20. The method of claim 15, wherein the generated messages are one of electronic mail messages, text messages, audio messages and video messages.
